(19) United States
(12) Patent Application Publication
(10) Pub. No.: US 2006/0160615 A1
(43) Pub. Date: Jul. 20, 2006

(54) System for table top gaming player interface

(75) Inventor: Scott A. Boyd, Las Vegas, NV (US)

Correspondence Address: BEYER WEAVER & THOMAS LLP, P.O. BOX 70250, OAKLAND, CA, 94612-0250, US

(73) Assignee: Acres Gaming Incorporated, Las Vegas, NV (US)

(21) Appl. No.: 11/040,181

(22) Filed: Jan. 20, 2005

(51) Int. Cl. A63F 13/00

(52) U.S. Cl. 463/30

(57) ABSTRACT

Embodiments of the invention include a table top electronic gaming machine player interface device with player tracking functionality and methods for retrofitting existing table top electronic gaming machines with player interfaces and tracking devices. The player interface device facilitates player interaction with the slot machine network to enable cashless gaming, player tracking, calendaring, player services and bonusing.

### BACKGROUND

1. Field of the Invention

The present invention relates to play on table top gaming machines and, more particularly, to an interface for players playing table top gaming devices for purposes such as communicating services, player tracking, and others.

2. Background of the Invention

For some time casinos have incorporated slot machines into a computer network to permit transactions from the slot machine to be communicated to the network and to permit the network to issue commands to a particular machine or group of machines. An example of the use of a communications board for such purposes is described, for example, in U.S. Pat. No. 5,655,961, which is owned by the assignee of the present application and which is incorporated herein by reference for all purposes.

Slot machines found in casinos, while networked together, are generally stand-alone machines and are upright or vertical in their orientation to enable the casino to place groups of machines closely together in a relatively small area. Such an orientation likewise permits players to stand or sit at the slot machines and to view displays at eye-level. It is well known to install a card reader, a display, and a keypad at each such slot machine to facilitate player tracking, as it is referred to in the industry. In a conventional player-tracking system, each player is assigned a card and an associated account, which is maintained on a network computer. Before playing one of the slot machines, the player inserts his or her card to cause points proportionate to play to accrue in his or her account. The points are then redeemable by the player for additional play, dinners, merchandise, or the like. In addition, the card, keypad and display, which is typically a vacuum fluorescent display or a small-character LCD display, can be used to permit a player to access a cashless play account or to access credits that are either complimentary or awarded to the player during the course of his or her play.

Table top machines are likewise found in casinos and other gaming establishments to permit players to sit at a table or bar while playing gaming machines. In this orientation, the player looks down at an angle at the table top device to play a given game. Because they are generally found in more social locations than traditional slot machines, table top machines require a low profile to allow game players to speak with other players, order drinks, or view sporting events on overhead television screens. Additionally, because bar areas are important revenue sources for casinos and other gaming establishments, table top gaming devices traditionally lack many of the features of traditional slot machines, such as player tracking devices.

The design, construction and operation of networked slot machines, including the card reader, the keypad and the display, as mentioned above, is described in detail in the '961 patent. The design, construction and operation of touch screen displays is described in detail in U.S. patent application Ser. No. 10/170,238, which is also owned by the assignee of the present application and which is incorporated herein by reference for all purposes. Another embodiment of networked slot machines is also described in U.S. Pat. No. 6,319,125 for a Method and Apparatus for Promoting Play on a Network of Gaming Devices, which is also assigned to the assignee of the present application and which is also incorporated herein by reference for all purposes.

In addition to player-tracking functions, cashless play and associated functions can be implemented using the system of FIG. 1 as described in U.S. patent application Ser. No. 09/694,065, which is assigned to the assignee of the present application and which is incorporated herein by reference for all purposes. In addition, conversion of player-tracking points into playable credit can also be implemented using the system of FIG. 1 as described in U.S. patent application Ser. No. 09/134,598, which is also assigned to the assignee of the present application and which is also incorporated herein by reference for all purposes.

### BRIEF DESCRIPTION OF THE DRAWINGS

FIG. 1A is a partial isometric view of a table top gaming device including a player interface that is part of an implementation of a first embodiment of the invention.

FIG. 1B is a partial isometric view of a table top gaming device including a player interface that is part of an implementation of a second embodiment of the invention.

FIGS. 2A and 2B together are a block diagram showing components of a gaming network according to embodiments of the invention.

FIG. 3-21 are enlarged views of the display screen depicted in FIGS. 1A and 1B with images displayed thereon as described in the following detailed description.

### DETAILED DESCRIPTION

Embodiments of the invention include a bar top or table top player interface device with player tracking functionality, among others, and methods for retrofitting existing table top or bar top gaming machines with player interfaces and tracking devices. As used in this description, electronic gaming devices, EGMs, bar top gaming devices, and table top gaming devices are used interchangeability to refer to table top electronic gaming devices. Player tracking, as used in this description, includes all communications between a given EGM, or set of given EGMs, and the network, including aspects of play and player tracking, as well as communications between the player and casino relating to services and calendaring.

Table Top Electronic Gaming Device

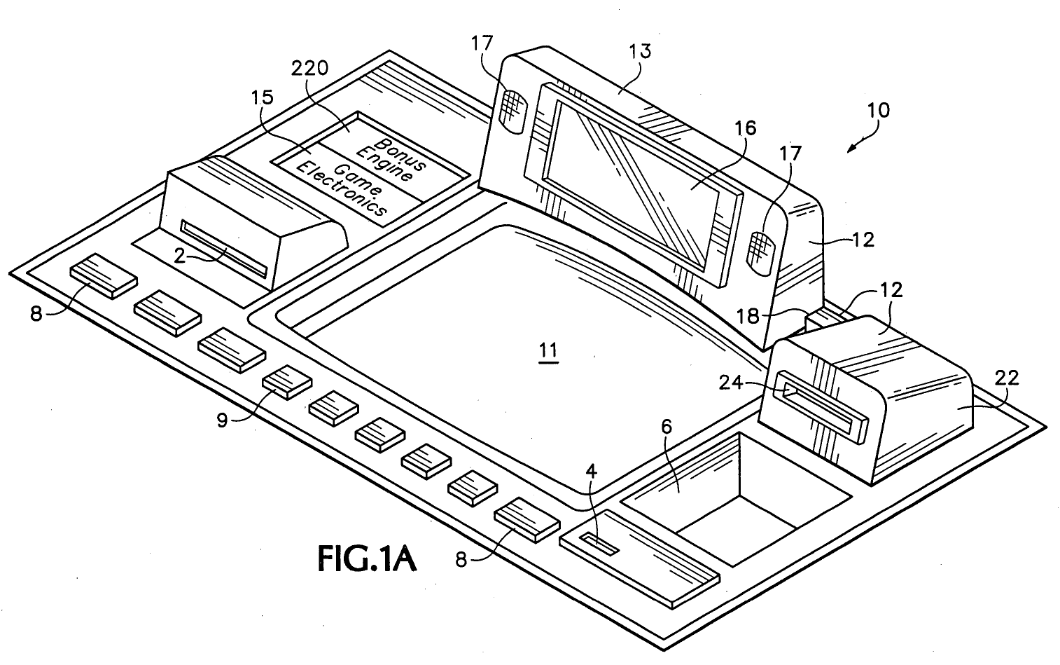

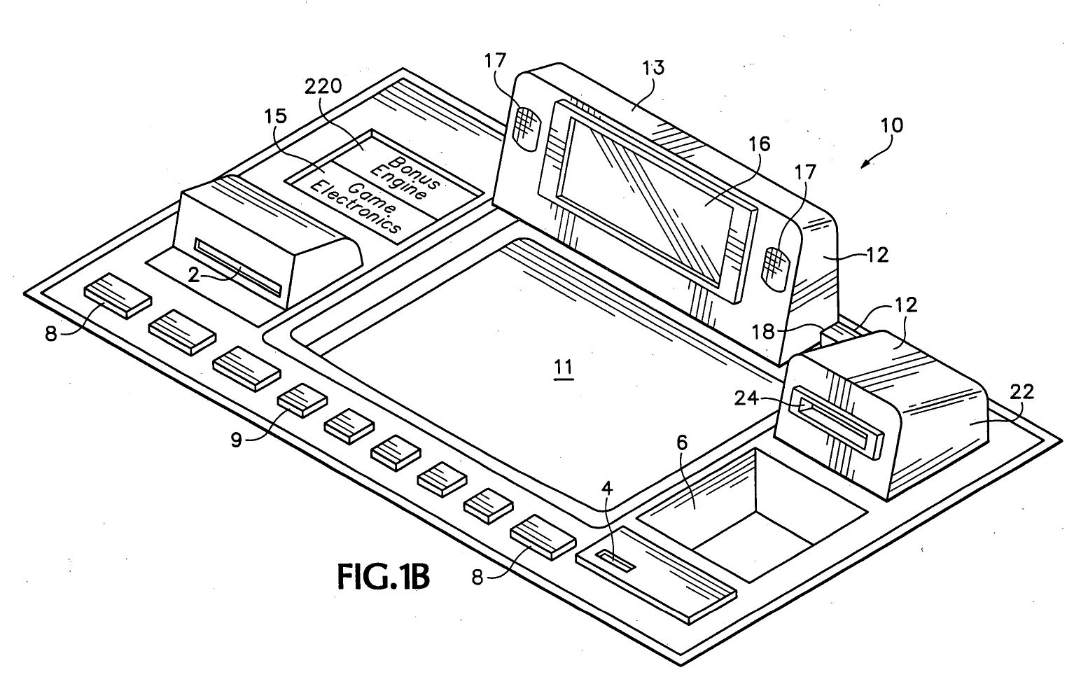

Turning to FIG. 1, a table top electronic gaming device (“EGM”) 10 according to an embodiment of the invention is shown. The EGM 10 includes a bill acceptor 2 that accepts and validates bills, tickets or vouchers. Bill validators operate by scanning barcodes or other identifying features on tickets or vouchers, and by examining printing or other security features on paper currency to determine authenticity. Bill validators are well known in the gaming arts.

The EGM 10 also includes one or more coin slots 4 for accepting coins or tokens. An internal hopper (located beneath the EGM 10 in FIGS. 1A and 1B and not shown) temporarily stores coins or tokens for later payment to the player through a payout bin 6, if the player chooses to cash out in such a manner.

A set of game electronics 15 manages the central operations of the gaming device 10. The game electronics 15 may be a main board that interfaces with various controller boards that control specific functions in the EGM 10, or may control the various devices directly. For example, the game electronics 15 counts the monetary value input into the EGM 10, and tracks and stores values for this and other data items. The game electronics 15 also control the game play of the EGM 10, such as by accepting user input from various buttons 8, 9 to cause credits to be wagered, as well as game results to be displayed, speakers to generate sound, and circuits to generate lights or video signals.

One of the items controlled by the game electronics 15 is an internal game printer (not shown). The game printer can be of any type known in the art, such as impact, inkjet, thermal, laser, and can be a color printer or standard black and white. Even if the game printer is only capable of printing in a single color, cardstock or paper used by the printer could be pre-printed in color. In lieu of an internal printer, the EGM 10 can be associated with a game and/or system printer, which can be located at the EGM 10 or be a stand-alone printer associated with one or more gaming devices.

An additional item that can be controlled by the game electronics 15 is the game display 11. The game display 11 provides a visual representation of the game and game outcome to the player and can be any type of display known in the art, including cathode ray tube (CRT), vacuum florescent display (VFD), plasma, LCD, or touchscreen, etc. The game display replaces traditional reels or mechanical devices with visual representations similar to such devices. The game display, when oriented horizontally as intended in a table top gaming device 10 can lie flat or can be a conventionally contoured or convex display where the central portion of the display projects above the plane created by the corners of the display.

Player Interface

The EGM 10 also includes game-mounted components of a player interface, including player tracking system. The components of the player interface are generally shown affixed to a frame 12, which is capable of being affixed or mounted to the gaming device 10. When so affixed, the player interface sits atop the table top gaming machine. While described as being atop the gaming machine, it is contemplated that the player interface can be located anywhere near the table top gaming machine. Although components of the tracking system interact with the EGM 10, it is a separate system from the gaming device.

The player interface affixed to the fame 12 includes three parts. The first part 13 contains a 640×240 touch-panel liquid crystal display (“LCD”) or touch screen display 16 and speakers 17. In the present embodiment of the invention, LCD 16 comprises a Hitachi SX16H005-AZA LCD. The speakers 17 can be made to produce sounds or music by the bonus engine 220, and can be in communication with the casino's sound system through the network to produce sounds, music or announcements throughout the entire casino, or through only portions of the casino. The second part of the frame in FIGS. 1A and 1B is an enclosed channel 18 connecting the first part of the frame 13 containing the display 16 and the third part of the frame 17, containing a card reader 22. The card reader 22 has a slot 24 (visible in FIGS. 1A and 1B), into which a player's card is received. The card reader can additionally be structured with a keypad to facilitate entry of a PIN number at the card reader. Alternatively, a representation of a keypad can be rendered on the display 16. The channel 18 secures the wiring and electronics necessary to support the player interface, including the display 16, speakers 17, and card reader 22, and to allow interface with the network 5 and player. While a touch screen display 16 is shown and described, alternate embodiments could use traditional displays, such as VFD, LCD, etc. Additionally, although the frame 12 is described as having three separate parts in association with one-another, it is contemplated that the frame 12 or player interface consists of a single unit incorporating the functionality of the display 16, speakers 17 and card reader 22, or of differently numbered units.

The frame 12 is in turn affixed or otherwise coupled to the table top gaming device 10, or a portion therof, and once coupled to the EGM 10 permits communication between the player and casino, including player tracking. Affixation can, but need not, be permanent to permit casinos or other gaming operators to move player interface devices to different machines as needed by the casino. To maximize the table area available for installation of the table top EGMs 10 while simultaneously preserving the player's overall comfort, the frame 12 is mounted directly to the table top EGM 10 or the game display 11 associated with the table top EGM. Alternatively, the frame 12 can be mounted or affixed to any structure in proximity with the EGM 10. As a result of differences in the contour of the game displays 11 associated with existing table top EGM 10 installations, the bottom surface of the frame 12 is shaped or structured to ensure that when installed, the frame meets the table top EGM 10 or game display 11 with sufficient flexibility to prevent damage to the base of the frame 12 or the EGM 10 or game display, while simultaneously ensuring a good fit between the frame 12 and EGM 10 or game display 11 to prevent food or drink from collecting under the base of the frame 12. Such flexibility can be obtained through well-positioned hardware, such as bolts, brackets, hinges and/or screws, or through materials such as rubber, plastic, or foam.

To permit casinos to continue to use existing player interface devices as existing table top EGMs 10 or game displays 11 are retired or are retrofitted to include player interface devices, frames 12 can be optionally configured to receive different bases, either permanently or temporarily, permitting the same frame to be installed with either a contoured display or a flat display. For example, different frame bases (not shown) could be slideably joined with a frame top 12, permitting a given player tracking system to be used with either a flat table top game display 11 or a conventionally contoured table top game display.

In addition to player tracking, the player interface affixed to the frame 12 can be used to communicate to the player about services offered by the casino or gaming establishment. Such services could include bonus opportunities, awards, promotions, dining or beverage services, emergency notification, player-to-casino communication, player-to-player communication, calendaring or event planning, broadcast or cable television, movies, videos, music, casino maps, show availability, etc. The player interface can likewise be used to accept communications from the player, such as player tracking sign-in or sign-up, food or beverage orders, award redemption, text messaging, credit purchase, ATM withdrawal, etc.

Player Tracking and Bonusing

The player interface, including the card reader 22 and display 16, is managed by functions operating on a “bonus engine” 220 which is a specialized piece of hardware used in the player tracking network. The bonus engine 220 manages the touch screen display 16, and card reader 22, as well as provides the bonusing and other functions described above. A player of the gaming device 10 uses a card and/or a PIN code to identify himself or herself to the player tracking system. The PIN can be entered at the card reader 22, if the card reader is structured with a keypad, or the PIN can be entered through a keypad represented on the display 16. Monetary value can be entered into the game at the display 16, either from the ID card itself, from a credit-card account with a bank or from a special gaming account managed by a casino. Alternatively, a player can use the card and/or PIN code to identify himself or herself, and then put credits on the machine by using the keypad 16 or by depositing coins, tokens, bills, or tickets/vouchers into the machine.

The bonus engine 220 is coupled by a computer connection to the gaming network, and plays a central role in the player tracking system. The bonus engine 220 is in constant communication between the game electronics 15 and the gaming network. The bonus engine 220 receives constant status updates about the state and status of the EGM 10. The game electronics 15 may automatically send information to the bonus engine 220, such as “events”, when the events occur, such as at the end of the game, or when a key event happens like a bill being accepted into the EGM 10. Or, the bonus engine 220 may send electronic updates, requests, or polls to the game electronics 15. When polled, the game electronics 15 sends the latest events to the bonus engine 220. Additionally, the gaming network can send commands and directives to a particular EGM 10 through the bonus engine 220 of that device. The bonus engine 220 then performs the commands, such as by displaying a message on the display 16, or the bonus engine delivers the commands to the game electronics 15 of that gaming device.

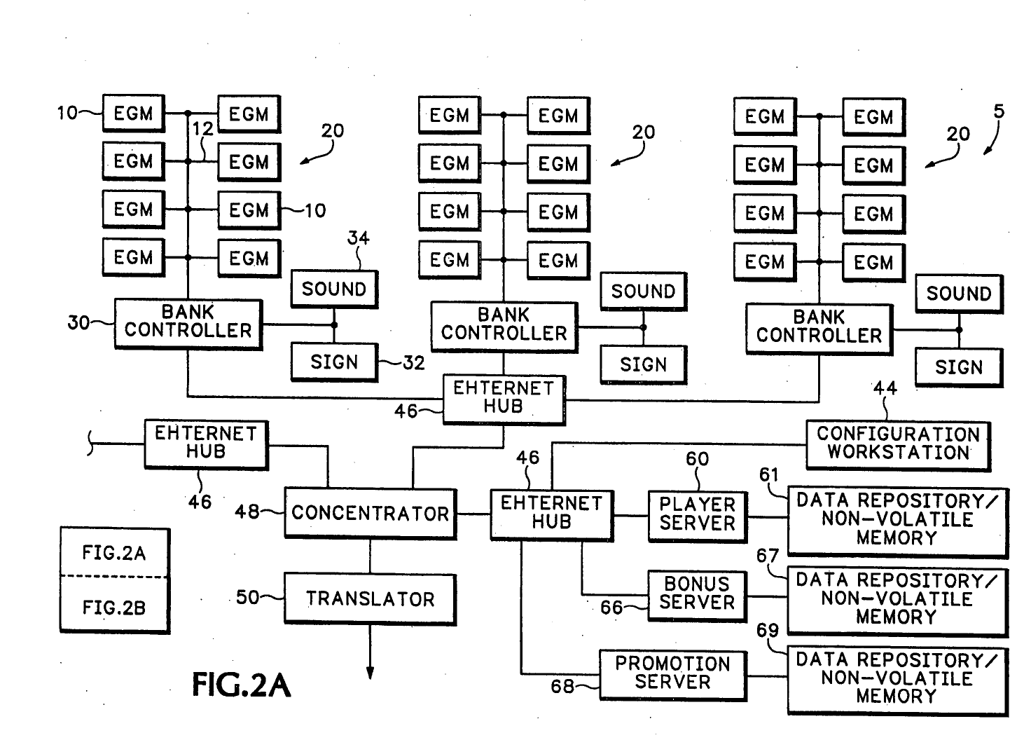

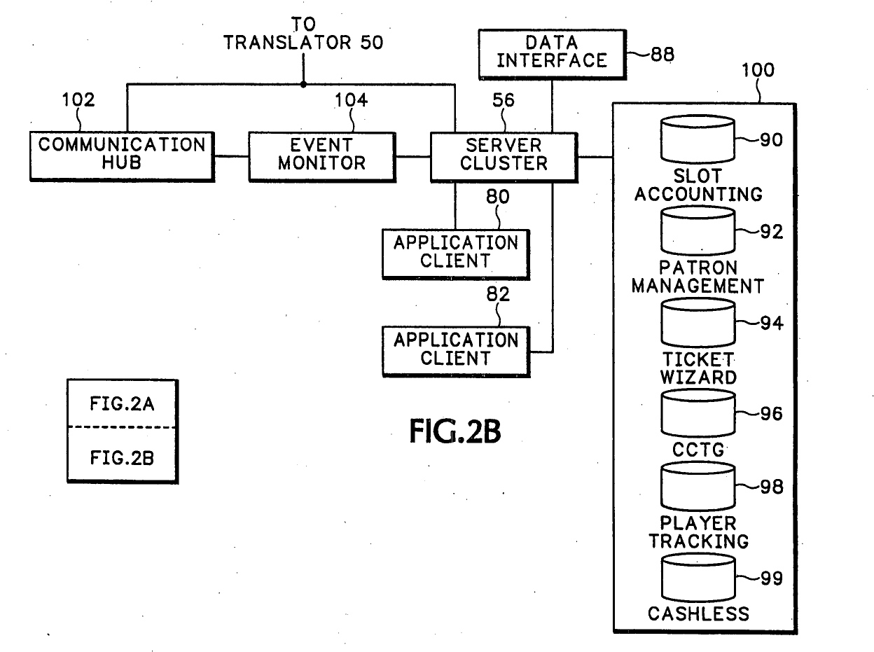

One such gaming network is illustrated in FIGS. 2A and 2B. In a gaming network 5, a number of EGMs 10 are organized in groups called banks. Individual banks 20 can contain almost any number of EGMs 10. Additionally, any number of banks is possible in a gaming network 5. The gaming network 5 illustrated in FIGS. 2A and 2B is only an example gaming network. Those skilled in the art will appreciate that embodiments of the invention can operate on any acceptable network, even if it differs from the one illustrated.

Each bank is controlled by a bank controller 30, which is coupled to each EGM 10 by a communication cable 12 (located below the table top EGM 10 and not shown). The bank controller 30 facilitates data communication between the EGMs 10 in its associated bank and the other components on the gaming network 5. In some embodiments, the bank controller 30 need not be present, and the EGMs 10 communicate directly with the other portions of the gaming network 5. The bank controller 30 can include audio capabilities, like an audio board or sound card for transmitting digitized sound effects, such as music and the like, to a sound system 34 coupled to the bank controller. Additionally, the bank controller 30 or sound system 34 may include a device for playing locally stored sounds, such as a hard-drive, CD or DVD-ROM drive. The bank controller 30 can also be connected to an electronic sign or screen 32 that displays information, such as scrolling, flashing, or other types of messages that indicate jackpot amounts and the like, which are visible to players of machines on a particular bank. Bank messages can likewise be display on the display 12. These message displays 32, 34 may be generated or changed responsive to commands issued over the network 5 to the bank controller 30. The sounds and images created by the bank controller may be identical for each of the banks 20 or all of sounds and images created by the banks may be different than the others.

Configuration data for the gaming network 5 is stored in one or more network data repositories 61, 67, 69. In some embodiments, the data repositories 61, 67, 69 are made of battery backed-up non-volatile SRAM (Static Random Access Memory), which provides dual advantages of having extremely fast data input and output, and having a power source that is independent from the network 5 or the EGMs 10. The data repositories 61, 67, 69 may also be mirrored, i.e., duplicate copies are made in real-time. This prevents data from being lost if one of the battery sources should fail or other catastrophic event. Data may be stored in the data repositories 61, 67 69 using CRCs (Cyclic Redundancy Checks) and timestamps to ensure the data is valid and non-corrupt.

Configuration data is created at a configuration workstation 44 and stored in the data repositories 61, 67, 69. Configuration data may include message data for players, which can be displayed on the display 12, as well as for promotions such as bonuses, which can likewise be communicated to the player via the display 12. Player message data is stored in the data repository 61, where it can be accessed by a player server 60. Player message data can include welcoming messages, card-in/card-out messages, and special messages about current promotions, for instance, all of which can be displayed on the display 12. The player server 60 reads the message data from the data repository 61 and sends a properly formatted message back to the bank controllers 30 and EGMs 10. These player messages may be displayed on a screen 32 for an entire bank, or may be shown on the display 16.

Other configuration data created at the configuration workstation 44 and stored in the data repositories 61, 67, 69 may include casino configuration data, such as identification of each EGM 10 on a casino floor. Additional parameters stored in the data repository 67, 69 are parameters used in promotions, such as bonus promotions. These parameters include such items as what EGMs IO are included in the promotion, such as which EGMs are capable of playing secondary games, how to fund a bonus, i.e., if a bonus is funded by a portion of the coin-in amount of the EGMs 10, whether a paid bonus is to be taxed or non-taxed, and other parameters.

As players play the EGMs IO in the gaming network 5, the EGMs send data from their coin meters, or meter values. One or more bonus server 66 stores these meter values, or summaries of the meter values, in its associated data repository 67.

The bonus servers 66 can also operate based on the present and stored meter values to determine an amount of money being wagered on the EGMs in near real-time. The bonus servers 66 can use the amount of money being wagered to calculate bonus pools that are funded as a percentage of the coin-in of participating EGMs 10. For instance, the bonus servers 66 can calculate a present amount of a bonus pool that is funded at one-half of one percent of the coin-in for the participating EGMs 10. An example of bonus promotions that can be operated from the bonus servers 66 includes LUCKY COIN and progressive bonuses, for example. Players can be provided with game information, such as game totals, bonuses, promotions, progressive jackpots, etc. via the display 16.

The promotion server 68, like the bonus server 66, can use an amount of money being wagered to calculate promotion pools funded as a percentage of the coin-in. Alternatively, the casino or operator can configure the promotion server 68 to award promotions not related to coin-in, for example, incentives for enrolling in player tracking programs.

The promotion server 68 may include functions and processes operative to generate signals to cause a system award to be generated and to communicate the generated system award to the particular EGM 10 at which the player receiving the award can be notified and receive the award via the display 16.

In determining when to grant a bonus, promotion or system award, if any, the promotion server 68 can access data stored anywhere on the network 5 looking for triggering events, such as: from any of the databases 100 described below; from any of the data repositories 61, 67, 69; from the bank controller 30; and from a bonus engine 220 (FIGS. 1A and 1B) on any or all of the EGMs 10 coupled to the gaming network.

When the promotion server 68 determines that a triggering event has been satisfied and that a system or bonus award should be generated, it sends appropriate signals to the bonus engine 220 of the appropriate EGM 10 through the gaming network S to deliver the award or initiate the game via the display 16. Records of awards, promotions, bonuses, and may be maintained by the promotion server 68 or elsewhere in the gaming network 5 for tracking and accounting purposes.

Of course, the servers 60, 66, 68 could be embodied in a single device, or in other configurations, and do not have to appear as in FIG. 2A, which is only a functional representation. Likewise, the data repositories 61, 67, 69 could be embodied in a single device.

As data is generated by the EGMs 10, data is passed through communication hardware, such as Ethernet hubs 46, and a concentrator 48. Of course, switches or bridges could also be used. The concentrator 48 is also coupled to a translator 50, which includes a compatibility buffer so that the data from the EGMs 10 can be used by a server cluster 56 (FIG. 2B), and other parts of the gaming network 5. A communication hub 102, in turn, is connected to the translator 50 and to an event monitor 104. The event monitor 104 is also coupled to a server cluster 56 (FIG. 2B). The server cluster 56 may, of course, be embodied by more than one physical server box. In practice, including multiple server boxes with dynamic load sharing and backup capabilities of one another ensures the gaming network 5 is nearly always operational.

The server cluster 56 is attached to and manages several databases, such as a slot accounting database 90, a patron management database 92, a ticket wizard database 94, a “Cage Credit and Table Games” (CCTG) database 96, a player tracking database 98, and a cashless database 99. These databases are collectively referred to as the databases 100. Of course these databases 100 are only exemplary, and more or fewer databases can be part of the gaming network 5. In some embodiments, particular servers in the server cluster 56 manage a single database. For example, a single server in the server cluster 56 may manage the slot accounting database 90, while another server manages the patron management database 92. Such implementation details are well within the expertise of one skilled in the art. However, for ease of illustration, FIG. 2B shows a single server cluster 56 that is coupled to all of the databases 100.

In operation, the slot accounting database 90 receives and stores statistical and financial information about the EGMs, such as dates, times, totals, game outcomes, etc. The patron management database 92 stores information regarding identified players, such as how often and which games they play, how often they stay in the casino, their total loyalty points, past awards, preferences, etc. The ticket wizard database 94 stores data about tickets that are issued by the EGMs, such as payouts and cashout tickets, as well as promotional tickets.

The CCTG database 96 stores information about non-EGM 10 data in a casino. That data is typically generated by a client station (not shown) coupled to one of the bank controllers 30. The client station can be located in a casino cage or at a table game, for instance, and data generated by the client station is forwarded to the CCTG database 96 where it is stored. For example, data such as when and how many chips a customer buys, when a customer creates or pays off markers, when a customer cashes checks, etc. is stored in the CCTG database 96.

The player tracking database 98 is a subset database of the patron management database 92, and is used when data retrieval speed is important, such as for real time promotions and bonusing. The cashless database 99 stores information about payment options other than bills, coins, and tokens.

Application clients 80 and 82 couple to the server cluster 56, and can retrieve data from any or all of the databases 100. Application programs run on an application client 80, 82 to provide users information about the gaming network 5 and the casino in which the network is established and to cause functions to operate on the gaming network 5. An example application client 80 could include, for instance, an accounting server that allows queries and provides reports on financial and statistical information on single or groups of EGMs 10.

A data interface 88 presents a uniform interface to other applications and servers (not shown), and grants access to retrieve data from the databases 100. Typically these other clients or servers would not be controlled by the same entity that provides the other components of the gaming network 5, and therefore the data interface 88 grants only guarded access to the databases 100.

Operation of the Touch Screen Display

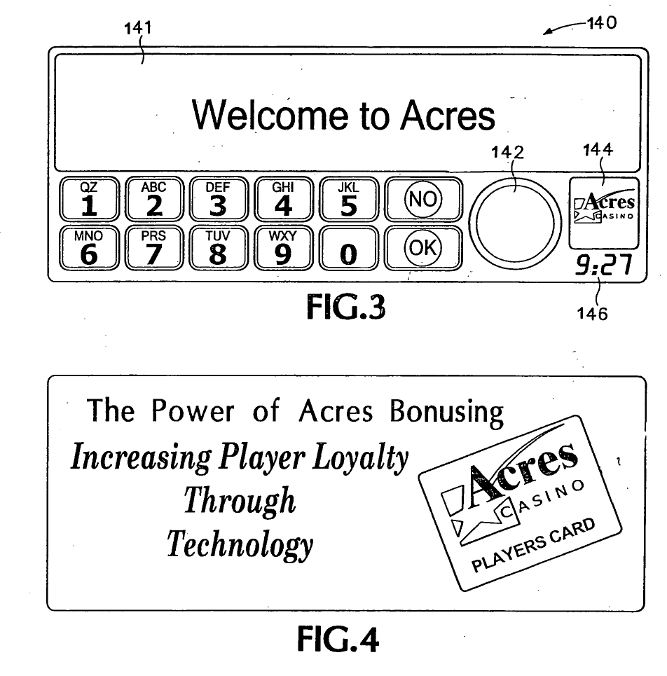

FIGS. 3 and 4 depict an example of display 16 in idle-attract mode, i.e., when there is no player card inserted in slot 24 (shown in FIGS. 1A and 1B) for player tracking and bonusing purposes. When there is no card, the system displays up to 32 full size screens in a repeating sequence. Using a computer and keyboard on the network, the operator can control the duration, time of day, and sound associated with the idle-attract mode.

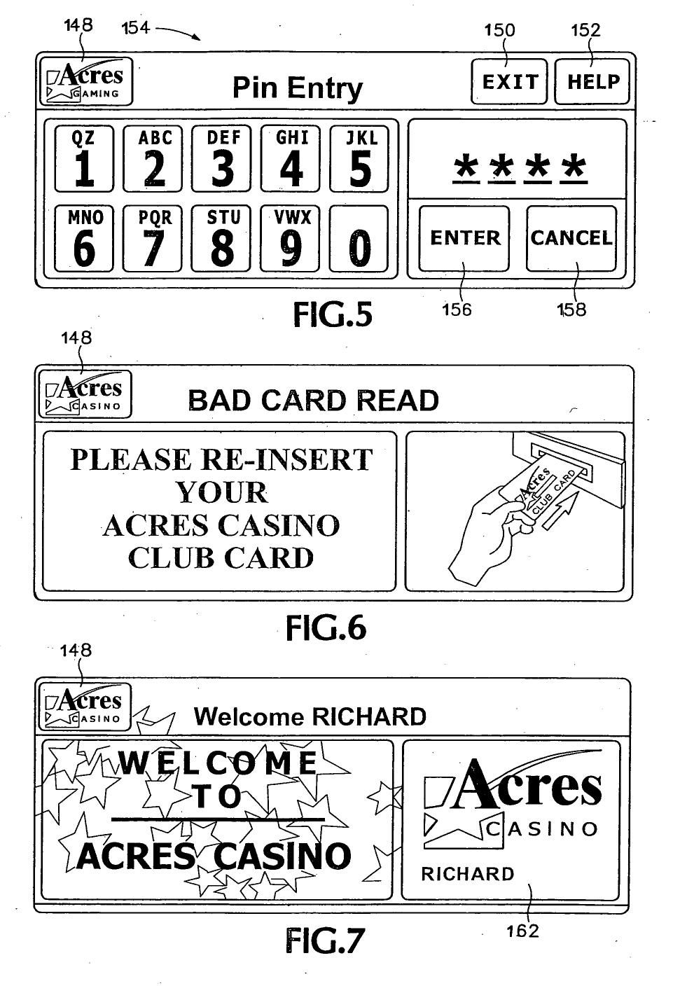

Turning to FIG. 5, the display is shown as it appears after a player enters his or her card into slot 24 of the card reader. This display includes a title, Pin Entry, PIN being an acronym for Personal Identification Number, a number that is stored on the network in association with the player's account. Also included is a casino logo 148, in the present embodiment of the invention, the Acres logo being utilized for illustrative purposes. In the upper right-hand corner of the display are an Exit button 150 and a Help button 152. Exit button 150 permits the player to cancel current operations or to move back to the previous screen. In FIG. 5, if Exit button 150 is pressed, the system resumes the idle-attract mode of FIGS. 3 and 4. Pressing Help button 152 retrieves up to 8 screens of help information that can be configured at the configuration workstation 44.

The display of FIG. 5 also includes a touch keypad 154, a touch Enter button 156, a touch Cancel button 158, and a PIN entry field 160, which displays an asterisk each time a digit from the player's PIN is entered on keypad 154.

In operation, when a player enters his or her card into slot 24, the FIG. 5 image appears on display 16 (shown in FIGS. 1A and 1B). The player enters the PIN associated with the player card by pressing the digits on keypad 154 and hitting Enter button 156. The system can be configured to change the number of PIN digits required. There is also an auto enter feature that can be implemented at the configuration workstation 44 that sends the PIN to the network 5 without waiting for the player to push the Enter button.

If, however, a player's card format cannot be recognized when it is inserted into slot 24, the display of FIG. 6 appears.

When the format is recognized and the PIN is transmitted to the network 5, the card information and PIN stored on a network computer is compared with those entered at gaming device machine 10. If there is a match, the image of FIG. 7 is displayed. The FIG. 7 image includes a personalized welcome, using the name associated with the player account, and a replica of the player card 162. Speakers 17 in FIGS. 1A and 1B, also play accompanying audio. The system operator can control the colors on the image of FIG. 7 via the configuration workstation. The screen will persist on the display for up to 30 seconds, a time that can also be configured by the operator on the configuration workstation.

In addition, the system is configured to require the PIN as described above each time the player is either requesting personal information, such as cash or point balances, or issuing commands to effect account changes, such as transferring cash to or from a slot machine. This provides increased account security, including protecting the player's account in the event that he or she leaves the game without withdrawing the card.

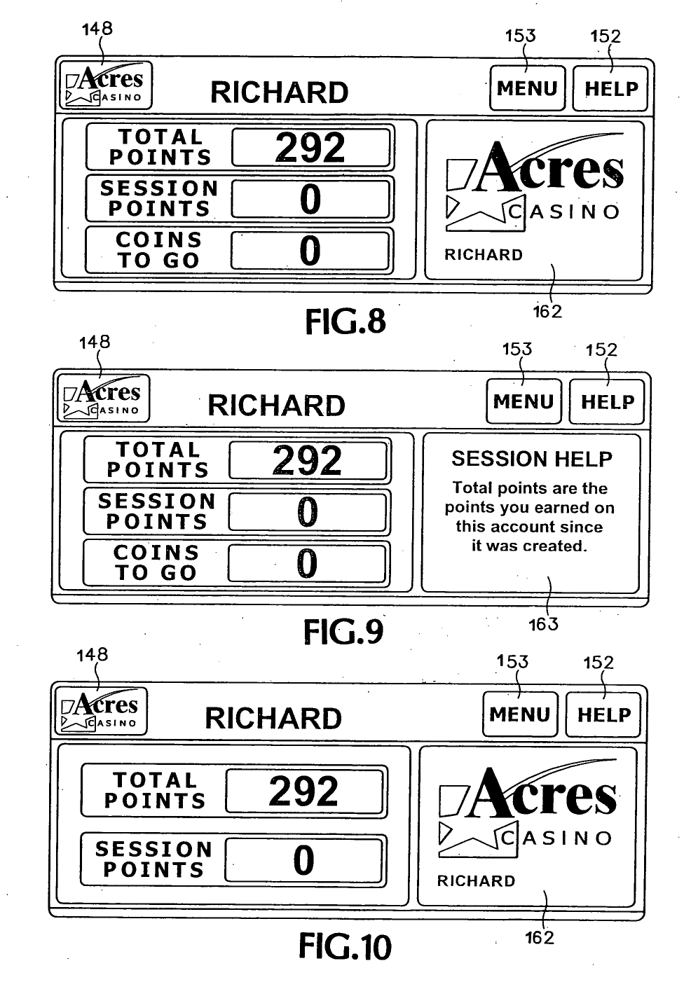

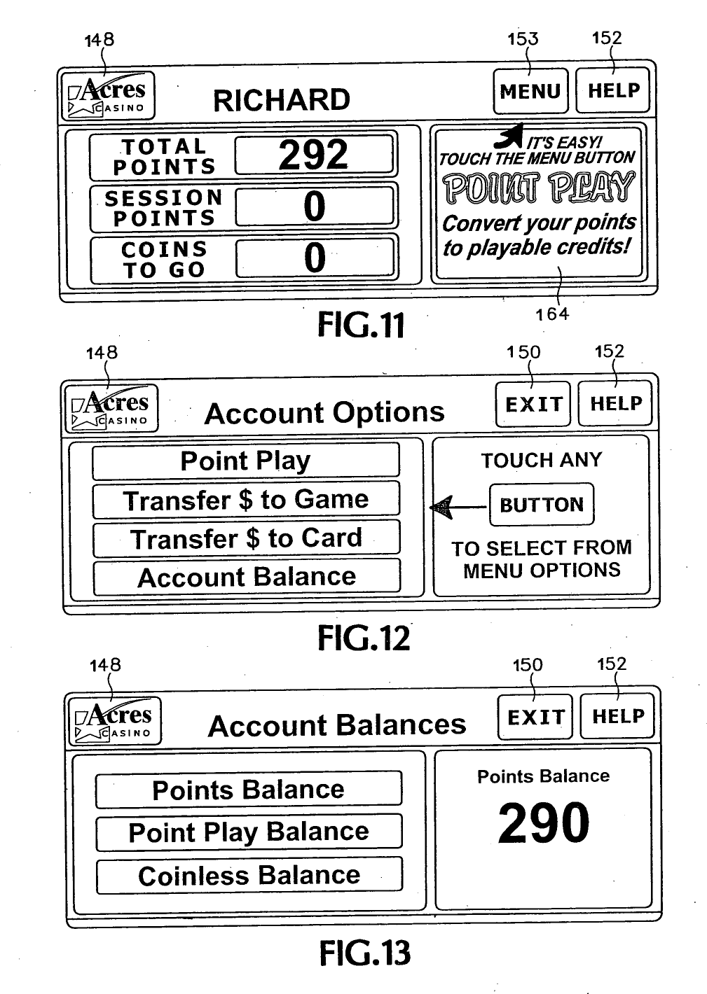

After the welcome screen of FIG. 7, a session screen, shown in FIG. 8 is displayed. A Menu button 153 calls the image of FIG. 11 as later discussed in more detail. The session image includes the player's name at the top and displays and updates the player's total player tracking points (Total Points), points accrued during the current session (Session Points), and additional coins to play necessary to generate additional points (Coins to Go). The Coins to Go display can be enabled or not depending upon the operator's preference, using the configuration workstation 44. The image of FIG. 8 persists until the player takes some action or the system interrupts the session screen with a higher priority display. FIG. 9 depicts another image of the FIG. 8 session screen after Help button 152 is touched. This displays a stored help screen relating to—in this case—the session screen. The help displayed is in the context of the current screen upon which Help button 152 is touched, i.e., the help relates to the display on the current screen.

FIG. 10 is another version of the FIG. 8 session screen. The FIG. 10 image does not include the Coins to Go field as a result of a configuration command entered by the casino operator on the configuration workstation 44.

FIG. 11 is still another implementation of the session screen of FIGS. 8 and 10, which includes a session-attract area 164. When the session-attract feature is implemented, area 164 is configurable to display up to 32 screens in any sequence. When the sequence ends, it repeats in round-robin fashion. Each displayable screen has a programmable duration, time of day control, and sound controls, all of which are programmable by the operator using the configuration workstation 44. The session-attract area may also be used to notify players of special events and awards.

FIG. 12 depicts a menu-mode screen, which is initiated when the player touches Menu button 153. Menu screens contain two touch screen buttons in the upper right-hand corner, namely Exit button 50 and Help button 152. As previously mentioned, the Exit button allows the player to cancel current operations or move back to the previous screen. Any of the four buttons on the left are pushed to select different menu options.

For example, touching the Account Balance button in FIG. 12 produces the menu display screen of FIG. 13. Pushing each of the buttons on the left of FIG. 13 provides the corresponding balance on the right of the screen. The Points Balance button provides the balance of player tracking points. Touching the Point Play Balance button shows the value of machine credits that have been converted by the player at the gaming machine from player tracking points. These credits are referred to by applicant as Xtra Credit points.

The Coinless Balance button in FIG. 13 provides a balance for a player's cashless play account.

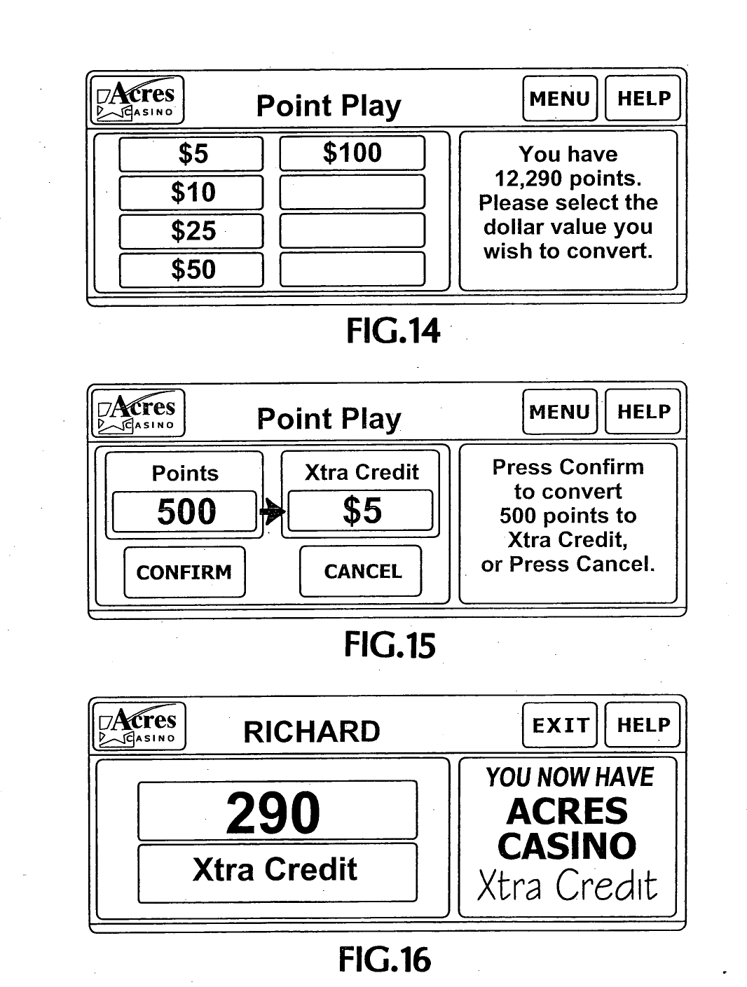

Returning again to FIG. 12, when Point Play button is touched, the image of FIG. 14 appears on the screen. This is the feature that allows players to convert their point balances into game playable credits (Xtra Credit). On the image of FIG. 14, the player selects one of the dollar amounts of credits that he or she wishes to exchange for points in the player's account. Touching, e.g., the $5 button in FIG. 14 produces the Point Play image of FIG. 15. Touching the Confirm button in FIG. 15 moves $5.00 of Xtra Credit to the player's Xtra Credit account, designated “Point Play Balance” in FIG. 13.

Turning now to FIG. 16, an Xtra Credit display replaces the Welcome display of FIG. 7 when a player has Xtra Credit. The player then plays off any Xtra Credit, and—after doing so—the session screen, like, e.g., the session screen of FIG. 8, is displayed.

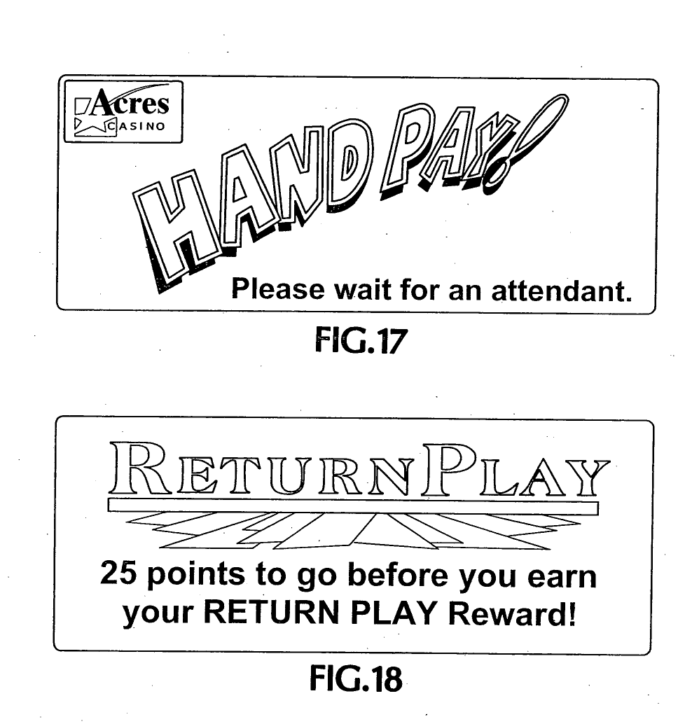

FIG. 17 illustrates a Hand Pay display, which appears whenever the slot machine is in a hand pay condition. This typically occurs for large jackpots or bonus awards that are too large to apply to the machine's credit meter. This display persists until the hand pay condition is cleared from the slot machine, typically by an attendant who arrives to clear the machine in a known manner.

FIG. 18 depicts a Return Play screen which is associated with a return play bonus. Briefly, upon earning a pre-determined number of points in a session, the player is awarded gaming credits that cannot be played until after a pre-determined later time. This induces the player to return to the casino to play off his or her credits.

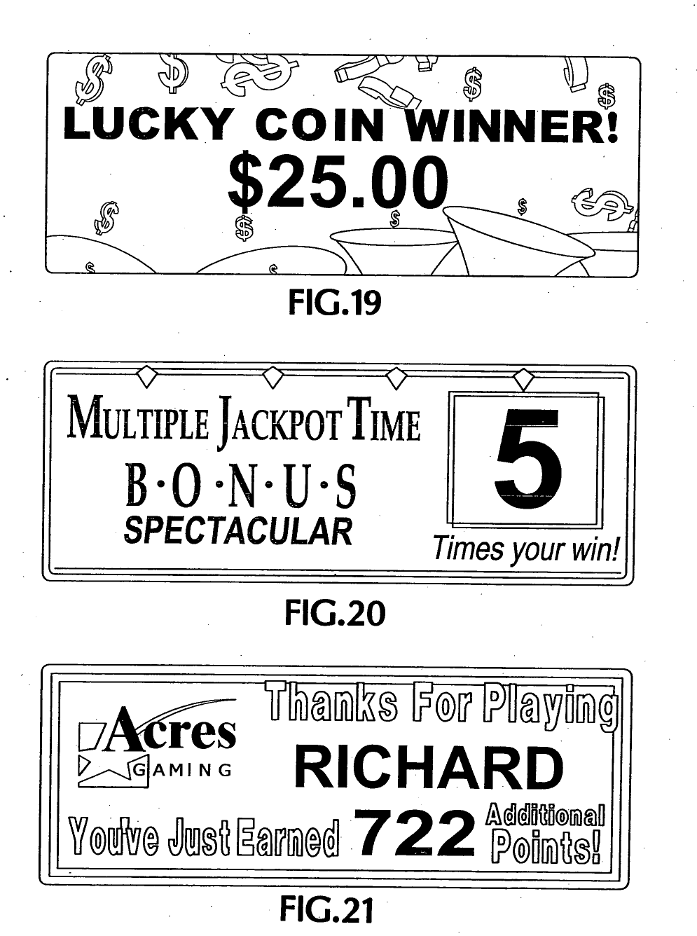

FIG. 19 depicts a screen that appears when the player is a winner of the Lucky Coin bonus, a random award that is described in applicant's U.S. Pat. No. 6,375,569, issued Apr. 23, 2002.

FIG. 20 informs the player that the multiple jackpot bonus is in effect, a bonus promotion.

Upon withdrawal of the player's card, the image of FIG. 21 is displayed. The image persists on the screen for a period of up to 10 seconds, which can be designated by the operator on the configuration workstation 44.

Using the system described with reference to FIGS. 1A and 1B and 2A and 2B, casinos can incorporate player interface devices with table top electronic gaming machines, can retrofit existing machines with player interface devices, and can use a single player interface device with gaming devices having different configurations to enhance a player's playing experience and encourage the player to place maximum wagers, while minimizing the casino's expenditure.

Although particular embodiments for incorporating player interface devices with table top electronic games have been discussed, it is not intended that such specific references be considered as limitations upon the scope of this invention, but rather the scope is determined by the following claims and their equivalents.

1. A method for operating networked gaming devices comprising:
associating one or more table top gaming devices with a gaming network;
permitting a player to play one of the table top gaming devices;
providing services to the player via the network, such services being related to play on the table top gaming device;
communicating information to the player about the network services via a touch screen display at the table top gaming device; and
accepting a communication from the player via the touch screen display.

2. The method of claim 1 wherein said services comprise crediting the player with a bonus award and wherein said information relates to the bonus award.

3. The method of claim 2 wherein said method further comprises displaying information about the award on said display.

4. The method of claim 2 wherein accepting a communication from the player via the touch screen display comprises accepting a communication relating to the bonus award.

5. The method of claim 1 wherein said services comprise player tracking services and wherein said information relates to player tracking.

6. The method of claim 5 wherein said method further comprises displaying information about player tracking on said display.

7. The method of claim 5 wherein accepting a communication from the player via the touch screen display comprises accepting a communication relating to player tracking.

8. The method of claim 5 wherein said information comprises accrued player-tracking points.

9. The method of claim 8 wherein accepting a communication from the player via the touch screen display comprises accepting a communication that converts the points to credits.

10. The method of claim 1 wherein said services comprise cashless-play services and wherein said information relates to cashless play.

11. The method of claim 10 wherein said method further comprises displaying information about cashless play on said display.

12. The method of claim 10 wherein accepting a communication from the player via the touch screen display comprises accepting a communication relating to cashless play.

13. The method of claim 10 wherein said information comprises an account balance.

14. The method of claim 13 wherein accepting a communication from the player via the touch screen display comprises accepting a communication that applies at least a portion of the account balance to the gaming device.

15. The method of claim 1 wherein said method further includes generating a video image on said display.

16. The method of claim 1 wherein a speaker is associated with at least one of the displays and wherein said method further includes generating an audio output on said speaker.

17. The method of claim 1 wherein said method further includes providing at least one help image on said display for providing information about the touch screen display.

18. The method of claim 17 wherein said at least one image is provided responsive to a communication from the player via the touch screen display.

19. A networked table top gaming device for communicating between a player and the network to which the table top gaming device is connected, the device comprising:
a host computer;
the network interconnecting the table top gaming device to the host computer;
a player interface coupleable to the table top gaming device; and
a touch screen display associated with the player interface, the touch screen display communicating information about services to a player of the networked table top gaming device.

20. The device of claim 19 wherein the touch screen display is configured to receive commands from a player.

21. The device of claim 19 wherein the player interface is removeably coupleable to the table top gaming device.

22. A system for communicating between a player of a table top gaming device and a network of gaming devices comprising:
a frame capable of coupling a player interface to a table top gaming device;
the table top gaming device being operatively connected to a computer, the computer generating information about services provided to one or more players on the network; and
a circuit associated with the player interface for creating images on a display associated with the interface responsive to such information.

23. The system of claim 22 wherein the display is a touch screen display.

24. The system of claim 23 wherein the touch screen display is configured to communicate information about services to a player of the table top gaming device.

25. The system of claim 24 wherein the touch screen display is configured to accept communications from the player.

26. A method for retrofitting a table top gaming device with a player interface comprising:
associating a mounting structure with the player interface;
mounting the player interface to the table top gaming device such that the player interface sits atop the table top gaming device; and
configuring the table top gaming device to communicate with the player interface.
